(19) United States
(12) Patent Application Publication
(10) Pub. No.: US 2025/0083700 A1
(43) Pub. Date: Mar. 13, 2025

(54) System and Method for Determining Optimal Lane for Vehicle Operation in Adverse Road Conditions

(71) Applicant: Vincent Loccisano, Wellesley, MA (US)

(72) Inventor: Vincent Loccisano, Wellesley, MA (US)

(21) Appl. No.: 18/957,813

(22) Filed: Nov. 24, 2024

(51) Int. Cl. B60W 60/00; B60W 10/20; B60W 50/14; G01C 21/36

(52) U.S. Cl. CPC B60W 60/001; B60W 10/20; B60W 50/14; G01C 21/3658; B60W 2552/00

(57) ABSTRACT

A system and method for using a variety of sensors monitors road conditions in real time determines the best lane for vehicle travel. The system may automatically choose the best lane, or assist a driver in making that decision. Its sensors include LIDAR sensors, vehicle wheel-speed and yaw sensors, acceleration sensors, and microphone sensors.

### BACKGROUND OF THE INVENTION

Increasingly sophisticated driver-assistance technologies, designed to enhance safety and convenience, use a range of sensors and cameras to monitor a vehicle's surroundings. Among current Advanced Driver-Assistance Systems (ADAS), the lane-change assist (LCA) feature helps drivers safely change lanes by notifying them that other cars are in the proximity of their own. LCA senses when a driver is about to incorrectly change lanes, and produces audible and or visual warnings. One type of LCA system leaves the driver in control of steering and braking. In another, more active type of assistance system, sensors on a vehicle actually control the lane change independently of the driver.

Blind-spot-monitoring and rear cross-traffic alerts are two safety features that use sensors to detect vehicles in areas that a driver may not be able to see. Blind-spot-monitoring typically uses radar sensors located in the rear bumper to detect vehicles in a driver's blind spots. When a vehicle is detected in a blind spot, a small light on a side mirror illuminates and may flash if a driver attempts to change lanes into that space. Rear cross-traffic alerts use the same radar sensors to detect vehicles approaching from either side when backing out of a parking space or driveway. If a vehicle is detected, an audible warning sounds and a visual alert illuminates on the car dashboard or rearview mirror.

A light-detection and ranging system (LiDAR) is a sensing method that uses pulsed laser light to measure variable distances to objects. Calculating the light's travel and wavelength, LiDAR creates 3D images of objects in a sensor's field of view. It is one technology used in ADAS to avoid collisions. In LiDAR scanning, a sensor can scan multiple directions.

Although all these systems are capable of checking for safe lane-changing, they do not determine which lane is optimal for driving in adverse road conditions. Traditional methods of lane determination may be compromised by factors such as snow, potholes, rutted pavement, and other road hazards that obscure road markings and reduce sensor accuracy.

### SUMMARY OF THE INVENTION

The present invention relates to a system and method for determining an optimal driving lane for vehicle operation under various adverse road conditions. The system and method uses a variety of sensors to monitor road conditions in real time, and can automatically choose the best lane, or assist a driver in making that decision. The system and method's sensors include forward facing sensors such as LiDAR sensors, sensors for monitoring vehicle speed and direction, such as vehicle wheel-speed sensors, yaw sensors, and acceleration sensors, and microphone sensors. An onboard processor gathers data from the sensors and generates high-resolution 3D images of road surfaces, algorithms interpret the data and perform calculations which are interpreted to determine an optimal lane. A user interface provides real-time feedback to a vehicle driver and provides cues to assist the driver in moving to the optimal lane.

In some embodiments a proximity sensor measures the distance between the vehicle and nearby vehicles or obstacles to assist the vehicle driver in safely changing lanes. A method of using the apparatus includes gathering information from the various sensors; analyzing sensor data; and detecting road conditions to determine an optimal driving lane. An onboard control system prompts a driver to move to an optimal driving lane.

In another embodiment, a method of using the apparatus in an autonomous vehicle involves gathering information from the various sensors; analyzing sensor data; and detecting road conditions to determine an optimal driving lane. An onboard control system actuates a steering-adjustment mechanism to steer the vehicle into the optimal lane.

### BRIEF DESCRIPTION OF DRAWINGS

FIG. 1 is a perspective view depicting sensor locations on a vehicle.

FIG. 2 is a perspective view depicting other sensor locations on a vehicle.

FIG. 3 is a diagram showing the system and method in user-driven mode.

FIG. 4 is a diagram showing the system and method in autonomous mode.

### DETAILED DESCRIPTION OF THE INVENTION

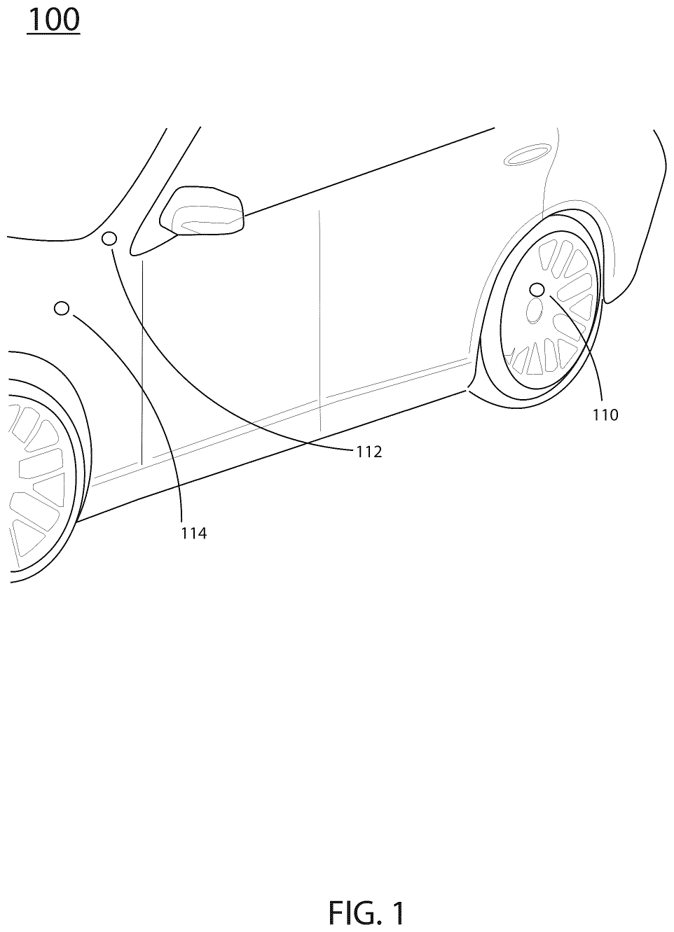

In FIG. 1, sensors for monitoring vehicle speed and direction include a vehicle wheel-speed sensor 110 and yaw sensors 112. These sensors provide data on the vehicle's speed, direction and stability, and the data is used to assist in lane determination. Acceleration sensors 114 detect changes in the vehicle's acceleration, especially when encountering bumps or potholes. One skilled in the art understands that a 3D acceleration sensor may be configured to measure speed, yaw and road conditions in response to the sensor readings. These sensors help identify uneven road surfaces and suggest lane changes to avoid such conditions.

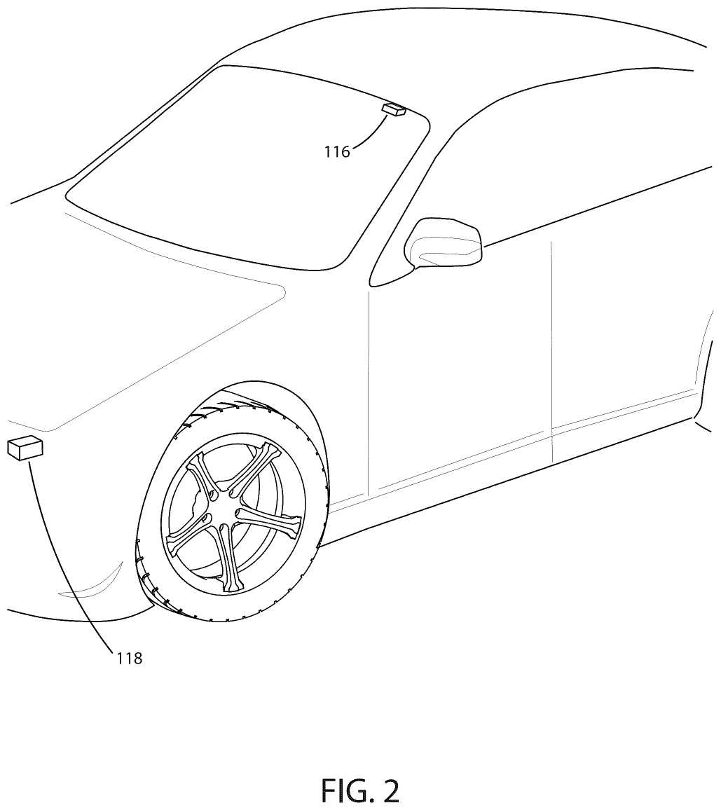

In FIG. 2, vehicle-mounted microphones 116 detect road noise such as the sound of tires on various road surfaces. This acoustic data helps identify changes in road texture and conditions, which can affect vehicle stability and comfort.

The system's forward-facing sensors 118 scan the road ahead and detect lane boundaries, obstacles, and adverse road conditions such as potholes, rutted pavement or snow and generate high-resolution 3D images of the road surface, even under adverse conditions. In some embodiments, these forward facing sensors are LIDAR sensors. In some embodiments proximity sensor(s) are located on the vehicle for detecting neighboring vehicles prior to generating visual and auditory alerts that assist in lane-changes.

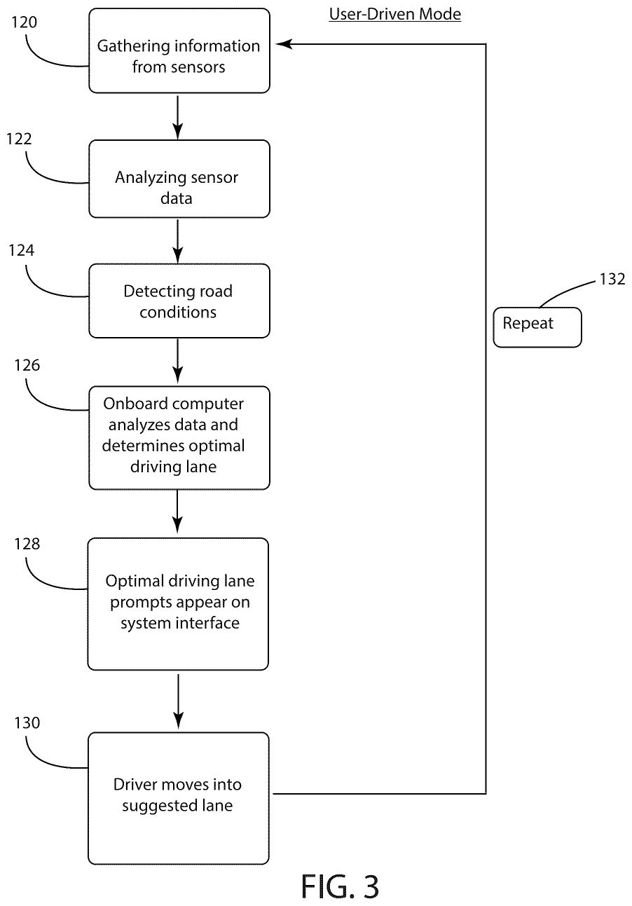

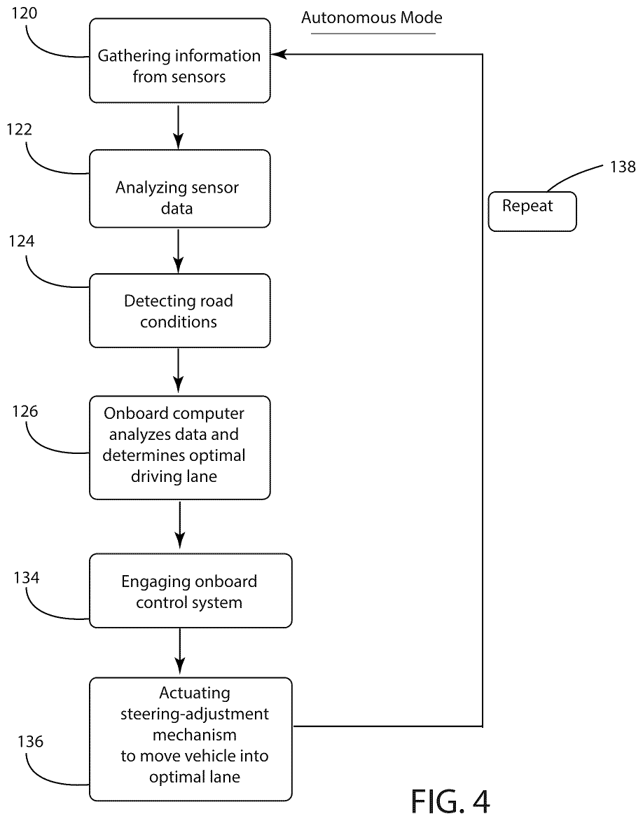

FIG. 3 and FIG. 4: Data from the LIDAR sensors, vehicle sensors, acceleration sensors, and microphone sensors is processed and analyzed by an onboard computer. The computer uses advanced algorithms to evaluate road conditions, detect lane boundaries, and identify potential hazards such as potholes, ruts, or snow. From this analysis, the system determines an optimal driving lane based on predetermined definitions of optimal. These predetermined definitions of optimal may be inherent in the vehicle programming or may be user defined or selectable. For example, in one embodiment of the present invention the system and method seeks to find the smoothest road conditions to maximize occupant comfort. In an alternative embodiment of the present invention the system may seek to minimize damage to the vehicle by avoiding road debris such as rocks or dirt that may damage the vehicle exterior paint or glass. The system and method's user interface gives a driver real-time feedback with visual and auditory alerts that assist in lane-changes.

Two example embodiments of the system and method are vehicle-operation modes, including an autonomous mode and a user-driven mode. When a vehicle is operating in user-driven mode, as shown in the diagram of FIG. 3, the system gives real-time feedback to a driver through a user interface. The interface displays visual alerts on the dashboard and gives auditory cues to guide a driver to the optimal lane. The system suggests the best lane according to evaluated road conditions, and updates the driver as conditions change.

An example method is illustrated in the diagram of FIG. 3. The method begins by gathering information from sensors 120; analyzing sensor data 122; and then detecting road conditions 124; the method continues by analyzing collected data for determining an optimal driving lane 126. The method continues by providing optimal driving-lane prompts that appear on a vehicle system interface, wherein the driver moves into the suggested lane 130 and the process repeats 132.

The diagram of FIG. 4 illustrates another example embodiment: that of the vehicle's autonomous mode. In this mode, the system automatically adjusts steering to navigate to an optimal lane. The onboard computer continuously monitors road conditions and adjusts the vehicle's path in real time to ensure smooth and safe travel.

The method begins by gathering information from sensors 120; analyzing sensor data 122; and then detecting road conditions 124. The method analyzes collected data for determining an optimal driving lane 126. The method continues by engaging an onboard control system 134 that, depending on input, actuates a steering-adjustment mechanism to move the vehicle into the optimal lane 136, wherein the method repeats 138.

1. A system for determining the optimal lane for vehicle travel under adverse road conditions comprising:
at least one forward-facing sensor fixedly engaged with a vehicle and electrically coupled with an onboard computer; and
at least one sensor for monitoring vehicle speed and direction, electronically coupled to the onboard computer; and
a user interface; wherein
the at least one forward-facing sensor is configured to scan a road in proximity of the vehicle to detect lane boundaries and road conditions, and to generate high-resolution 3D images of road surfaces; and the at least one sensor for monitoring vehicle speed and direction is configured to monitor the vehicle's movement and orientation; and the onboard computer gathers data from each sensor and performs calculations, which are sent to and interpreted by the user interface, which is configured to provide real-time feedback to a vehicle driver.

2. The system of claim 1, wherein:
the at least one forward facing sensor is a LiDAR sensor.

3. The system of claim 1 wherein:
the sensor for monitoring vehicle speed and direction is a wheel-speed sensor.

4. The system of claim 3 wherein:
the wheel-speed sensor is coupled with the at least one yaw sensor.

5. The system of claim 1 further comprising:
at least one acceleration sensor configured to detect changes in vehicle acceleration due to road conditions, electronically coupled to the onboard computer.

6. The system of claim 1 further comprising:
at least one microphone configured to detect road noise.

7. The system of claim 1, wherein
the onboard computer uses algorithms to evaluate road conditions, detect lane boundaries and identify potential hazards.

8. The system of claim 1 wherein:
the onboard computer uses algorithms to evaluate road conditions, detect lane boundaries and identify potential hazards.

9. The system of claim 1 further comprising:
at least one proximity sensor configured to detect neighboring vehicles and generate a signal in advance of providing real-time feedback to the vehicle driver.

10. The system of claim 1 wherein:
the system operates in automatic mode to control the vehicle's steering to navigate to an optimal lane.

11. The system of claim 1 wherein:
the system operates in user-driven mode to provide real-time feedback and lane recommendations to the driver.

12. A user-driven method for using the system of claim 1, the method comprising:
gathering information from said sensors; and
analyzing sensor data; and
detecting road conditions; and
generating 3D images of road surfaces from analyzed sensor data; and
determining an optimal driving lane; and
providing optimal-driving-lane prompts on a vehicle user interface; wherein
a driver moves into to said optimal driving lane, and the method repeats.

13. An autonomous-driven method for using the system of claim 1, the method comprising:
gathering information from said sensors; and
analyzing sensor data; and
detecting road conditions; and
determining an optimal driving lane; and
engaging onboard control system; and
actuating a steering-adjustment mechanism to steer the vehicle into the optimal lane, and the method repeats.
